(19) United States
(12) Patent Application Publication
(10) Pub. No.: US 2011/0093705 A1
(43) Pub. Date: Apr. 21, 2011

(54) METHOD, DEVICE, AND SYSTEM FOR REGISTERING USER GENERATED CONTENT

(76) Inventors: Yijun Liu, Shenzhen (CN); Hodgtao Gao, Shenzhen (CN)

(21) Appl. No.: 12/939,030

(22) Filed: Nov. 3, 2010

Related U.S. Application Data
(63) Continuation of application No. PCT/CN2009/071752, filed on May 12, 2009.

(30) Foreign Application Priority Data
May 12, 2008 (CN) 200810106367.6

(51) Int. Cl. H04L 9/32; G06F 21/00

(52) U.S. Cl. 713/168; 726/6

(57) ABSTRACT

A method, a device, and a system for registering user generated content (UGC) are provided. The method for registering UGC includes the following steps. A content registration request is received, in which the content registration request carries a UGC and a guarantee credential corresponding to the UGC, and the guarantee credential is generated by a third party network entity. The UGC is registered according to the guarantee credential. The device and the system correspond to the method. Therefore, the registration of UGC is realized with a simple, feasible, and diversified registration method.

### CROSS-REFERENCE TO RELATED APPLICATIONS

This application is a continuation of International Application No. PCT/CN2009/071752, filed on May, 12, 2009, which claims priority to Chinese Patent Application No. 200810106367.6, filed on May 12, 2008, both of which are hereby incorporated by reference in their entireties.

### TECHNICAL FIELD

The present invention relates to the field of network technology, and more particularly to a method, a device, and a system for registering user generated content (UGC).

### BACKGROUND

A UGC usually refers to a content generated by an ordinary user, for example, text, picture, video, audio, and various forms of works created by users and uploaded to groups and blogs. Usually, the user freely uploads the personally created content to a certain fixed website, that is, the UGC is usually uploaded to a certain fixed website, so as to bring certain benefits to the website. Due to the free uploading, it cannot be ensured that the uploader is the real author of the content, so that the benefit of the real author of the UGC is affected, and the creation enthusiasm of the author is hurt. Meanwhile, due to the free uploading, the content may be freely forwarded to other websites, so that the influence of the website to which the user uploads the content is limited. Therefore, the content needs to be registered for the subsequent management. However, for the author of the UGC, the procedure of the existing registration manner is too complicated, even more complicated than the procedure of creating the UGC, so that if the existing content registration manner is applied to the procedure of registering the UGC, a high registration cost and a complicated registration manner are resulted in.

### SUMMARY

The embodiments of the present invention is directed to a method, a device, and a system for registering UGC, thereby solving the problem that an existing content registering manner is complicated with a high cost.

Accordingly, an embodiment of the present invention provides a method for registering UGC, which includes the following steps.

A content registration request is received, in which the content registration request carries a UGC and a guarantee credential corresponding to the UGC, and the guarantee credential is generated by a third party network entity.

The UGC is registered according to the guarantee credential.

An embodiment of the present invention also provides a device for registering UGC, which includes a receiving module and a registration module.

The receiving module is configured to receive a content registration request, in which the content registration request carries a UGC and a guarantee credential corresponding to the UGC, and the guarantee credential is generated by a third party network entity.

The registration module is configured to register the UGC according to the guarantee credential.

An embodiment of the present invention further provides a system for registering UGC, which includes a website and a content identity manager (CIM).

The website is configured to receive a UGC sent by a user, and generate a corresponding guarantee credential for the UGC.

The CIM is configured to receive a content registration request, in which the content registration request carries the UGC and the guarantee credential, and is configured to register the UGC according to the guarantee credential.

It can be known from the technical solutions described by the embodiments of the present invention, the website to which the UGC is uploaded provides the guarantee, and the CIM registers the UGC according to the guarantee provided by the website, so that the UGC is registered with a simple and feasible registration process.

### BRIEF DESCRIPTION OF THE DRAWINGS

FIG. 1 is a schematic flow chart of an embodiment of a method for registering UGC according to the present invention;

FIG. 2 is a schematic flow chart of a first example of the embodiment of the method for registering UGC according to the present invention;

FIG. 3 is a schematic flow chart of ID registration in the embodiment of the method for registering UGC according to the present invention;

FIG. 4 is a schematic flow chart of a second example of the embodiment of the method for registering UGC according to the present invention;

FIG. 5 is a schematic structural view of a first embodiment of a device for registering UGC according to the present invention;

FIG. 6 is a schematic structural view of a second embodiment of the device for registering UGC according to the present invention;

FIG. 7 is a schematic structural view of a first embodiment of a system for registering UGC according to the present invention; and

FIG. 8 is a schematic structural view of a second embodiment of the system for registering UGC according to the present invention.

### DETAILED DESCRIPTION

Technical solutions of the present invention are further described in detail with reference to the accompanying drawings and embodiments.

A content registration refers to a procedure of applying from authoritative agencies for a relevant characteristic description of a content serving as an independent individual. In subsequent operation and management procedures relevant to the content, other attribute descriptions of the individual may be associated according to the characteristic description. For the content registration, usually a content provider is required to provide relevant evidence documents having force and effect, when providing the content to a management entity, for example, a CIM, to register, so as to authenticate that the provided content is owned by the person applying for the registration. For example, if a software developer intends to register the newly finished software, the software developer needs to provide the certificates from the authoritative agencies, a certificate of legal person from an enterprise, and a novelty assessment report from state authoritative departments. In the following embodiment, a trusted third party (TTP) provides a guarantee credential, and a detailed process is described in the following.

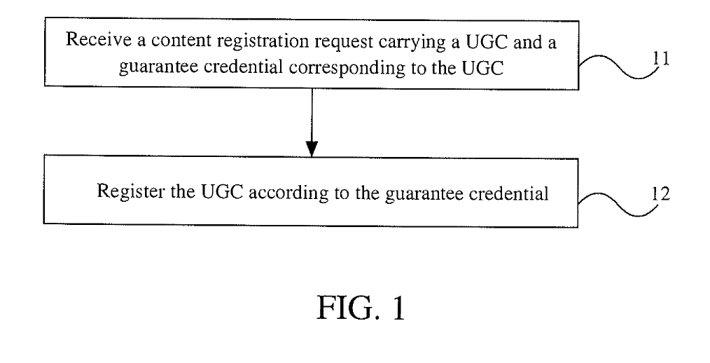

FIG. 1 is a schematic flow chart of an embodiment of a method for registering UGC according to the present invention. The embodiment includes the following steps.

In step 11, a CIM receives a content registration request, in which the content registration request carries a UGC and a guarantee credential corresponding to the UGC, and the guarantee credential is generated by a third party network entity, for example, a website to receive the UGC.

In step 12, the CIM registers the UGC according to the guarantee credential.

In this embodiment, the website to which the UGC is to be uploaded provides the guarantee credential, so that the CIM finishes registering the UGC according to the guarantee credential, so the registration is simple and feasible.

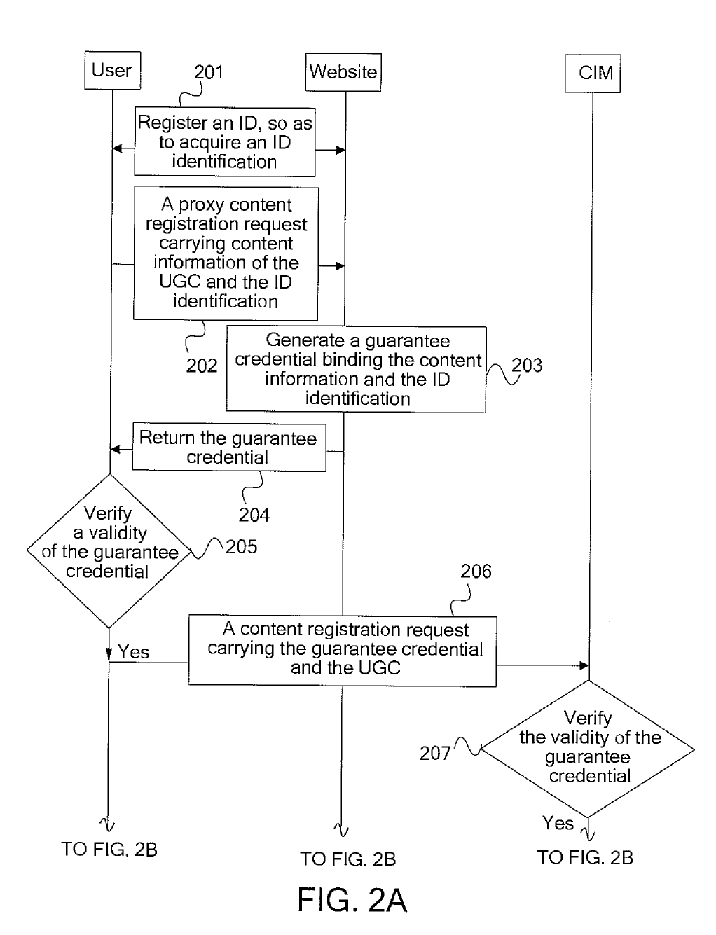

FIG. 2 is a schematic flow chart of a first example of the embodiment of the method for registering UGC according to the present invention. As compared with the embodiment as shown in FIG. 1, this embodiment includes steps 201-203 before step 11.

In step 201, a user performs an identity (ID) registration on a website, for example, a website proxy agent (WPA), so as to acquire an identification identifier User_ID, the website is configured to receive and publish the uploaded UGC, and the UGC needs to be registered to the CIM before being published on the website, thereby ensuring benefits of a real author of the UGC.

In step 202, the user sends a proxy content registration request to the website waiting to receive the UGC. The proxy content registration request carries the UGC, the ID identification, and a registration mode indicating, for example, whether a user self-application mode or a website direct proxy mode is adopted. A specific parameter description of the content registration request may be Content_Hash+User_ID+Regist_Mode, including a content hash value Content_Hash of the UGC to be applied for registration, the ID identification User_ID, and the registration mode Regist_Mode. For sake of the security of the UGC, in this embodiment, the user uploads the content hash value Content_Hash as the UGC to the website, alternatively, if the website is sufficiently trusted, the user may also upload the UGC content itself Content.

In step 203, the website generates the guarantee credential according to the UGC and the ID identification, in which the guarantee credential is configured to bind the UGC and the ID identification. A specific parameter description of the guarantee credential may be Sign_{WPA}(Hash(Content_Hash+User_ID+TimeStamp)), hereafter referred to as Sign_{WPA}(P*) for short, for ease of illustration. Specifically, the WPA makes the received content hash value Content_Hash, the assigned ID identification User_ID, and a relatively correct time during the operation (or a timestamp acquired from a time authoritative management entity) TimeStamp to be connected in series, performs a hash operation, and performs a signature calculation by using a private key corresponding to a relevant public certificate of the WPA, so as to acquire the guarantee credential, for ensuring that the UGC is owned by the user having the User_ID.

When the website generates the corresponding guarantee credential for the UGC, the UGC is registered to the CIM. As compared with the embodiment as shown in FIG. 1, in step 11 of this embodiment, the CIM receives the content registration request sent by the user, which specifically includes steps 204-207.

In step 204, if the registration mode carried in the proxy content registration request indicates that the user self-application mode is adopted, the website returns the guarantee credential Sign_{WPA}(P*) to the user.

In step 205, the user verifies the validity of the guarantee credential, so as to determine whether the website generates the guarantee credential for the UGC to be registered, and the user verifies the guarantee credential, so as to determine that the WPA primarily guarantees a right of attribution of the UGC. That is to say, the user executes a Veri(Sign_{WPA}(P)) operation. If the guarantee credential is valid, step 206 is performed.

In step 206, the user sends the content registration request to the CIM. The content registration request carries the UGC to be registered and the guarantee credential corresponding to the UGC and generated by the website. The specific code of the content registration request may be

Enc_{RAND}(Content+User_ID+Sign_{WPA}(P*)+WPA_URL)+Enc_{CIM}_{_{—}}_{PubKey}(RAND).

For the parameters, Content is the content itself of the UGC to be registered, User_ID is the ID identification acquired by the user after registering on the website, Sign_{WPA}(P*) is the guarantee credential acquired after the website performs an acknowledgement signing on the UGC provided by the user, and WPA_URL is a resource ID of the website to receive the UGC. A security channel is not established between the user and the CIM in advance, so that when the above parameters are transmitted, the parameters must be encrypted. Specifically, the parameters are transmitted after being encrypted by using a session key RAND, and the session key RAND is transmitted to the CIM after being encrypted by a public key certificate of the CIM, and transmission parameters include an attribute description list of the content.

That is to say, encryption processes Enc_{RAND}(Content+User_ID+Sign_{WPA}(P*)+WPA_URL) and Enc_{CIM}_{_{—}}_{PubKey}(RAND) are respectively performed.

As compared with the embodiment as shown in FIG. 1, step 12 in this embodiment specifically includes steps 207-209.

In step 207, the CIM verifies the validity of the guarantee credential, that is, determines whether the guarantee credential comes from a trusted website. If the guarantee credential comes from a trusted website, step 208 is performed.

In step 208, the CIM verifies the applicability of the UGC, that is, verifies whether the UGC may apply for registration in the CIM management domain. If the UGC may apply for registration in the CIM management domain, step 209 is performed.

In the above verification process, the applicability of the UGC may be firstly verified, and then the guarantee credential is verified. If one of the above items does not pass the verification, error information will be generated.

A specific parameter description of the verification process may be

Extract(Content+User_ID+Sign_{WPA}(P*))₊Veri_{CIM}_{_{—}}_{PrvKey}(Sign_{WPA}(P*)).

That is to say, the CIM firstly performs a decryption by using the corresponding private key, to acquire the session key RAND, and then performs the decryption by using the session key, to acquire the corresponding parameter set including Content, User_ID, and Sign_{WPA}(P*), that is, the decryption operation

Extract(Content+User_ID+Sign_{WPA}(P*)) is performed to acquire the above parameter set.

Then, it is verified whether Content provided by the user can be registered in the CIM management domain. If the Content provided by the user can be registered in the CIM management domain, the validity of the guarantee credential Sign_{WPA}(P*) provided by the WPA is verified, that is, a verification operation Veri_{CIM}_{_{—}}_{PrvKey}(Sign_{WPA}(P*)) is executed. If the verification succeeds, a next operation of generating a content ID is triggered; if the verification does not succeed, error information is generated.

In step 209, the content ID Cntnt_ID corresponding to the UGC, the corresponding attribute description list Attribute_List and the acceptance credential are generated. The detailed operation parameter description may be

Generate(Cntnt_ID+Attribute_List)+Sign_{CIM}_{_{—}}_{PrvKey}(P*+Cntnt_ID).

The detailed algorithm is described as follows. Firstly, the Cntnt_ID and the Attribute_List are generated, the corresponding content ID Cntnt_ID and the attribute description list are stored in a special database, and the attribute description list may be configured to determine that whether the content subsequently to be applied for registration can be applied in the CIM domain. That is to say, the Generate(Cntnt_ID+Attribute_List) operation is performed.

Then, a signature calculation is performed by using the private key of the CIM corresponding to the content ID promulgation certificate, so as to generate the acceptance credential configured to bind the parameter set and the Cntnt_ID, in which the acceptance credential is configured to enable the website waiting to receive the UGC to know that the content to be applied for registration is successfully registered, so as to lawfully publish the successfully registered UGC.

That is to say, the Sign_{CIM}_{_{—}}_{PrvKey}(P*+Cntnt_ID) operation is performed.

In order to publish the registered UGC on the website, this embodiment may further include steps 210-214.

In step 210, the CIM sends the content ID and the acceptance credential to the user through the security channel, and the detailed operation code is Enc_{RAND}(Sign_{CIM}_{_{—}}_{PrvKey}(P*+Cntn_ID)+Cntnt_ID). Alternatively, the CIM sends the generated error information to the user.

In step 211, after receiving the information returned by the CIM and determining that the information is not the error information, the user verifies the validity of the acceptance credential generated by the CIM. If the acceptance credential is valid, that is, the acceptance credential comes from the valid CIM, step 212 is performed. The detailed operation parameter description is

Veri(Sign_{CIM}_{_{—}}_{PrvKey}(P*+Cntnt_ID))+Get(Cntnt_ID).

The detailed algorithm is described as follows. After receiving the data sent by the CIM, if the data sent by the CIM is not the error information, the user decrypts the data packet by using the RAND, and verifies the acceptance credential Sign_{CIM}_{_{—}}_{PrvKey}(P*+Cntnt_ID), that is, Veri(Sign_{CIM}_{_{—}}_{PrvKey}(P*+Cntnt_ID)). If the acceptance credential passes the verification, the content ID Get(Cntnt_ID) is acquired, indicating that the UGC is successfully registered on the CIM.

In step 212, the user uploads the content itself Content of the UGC applied for registration and the corresponding acceptance credential to the website, or sends the decryption key of the originally uploaded encrypted UGC (for example, the content hash value Content_Hash) to the website. The detailed operation parameter description may be that the user sends Content+Cntnt_ID+Sign_{CIM}_{_{—}}_{PrvKey}(P*+Cntnt_ID) to the website.

In step 213, the website verifies the validity of the acceptance credential. If the acceptance credential is valid, it is compared whether the content itself Content of the uploaded UGC and the content hash value Content_Hash are consistent, and if they are consistent, step 214 is performed; if they are consistent, other operations are performed according to the preset policy. The detailed operation parameter description can be

Veri(Sign_{CIM}_{_{—}}_{PrvKey}(P*+Cntcn_ID))+Comp(Content,Content_Hash).

In step 214, the UGC is published according to the preset policy.

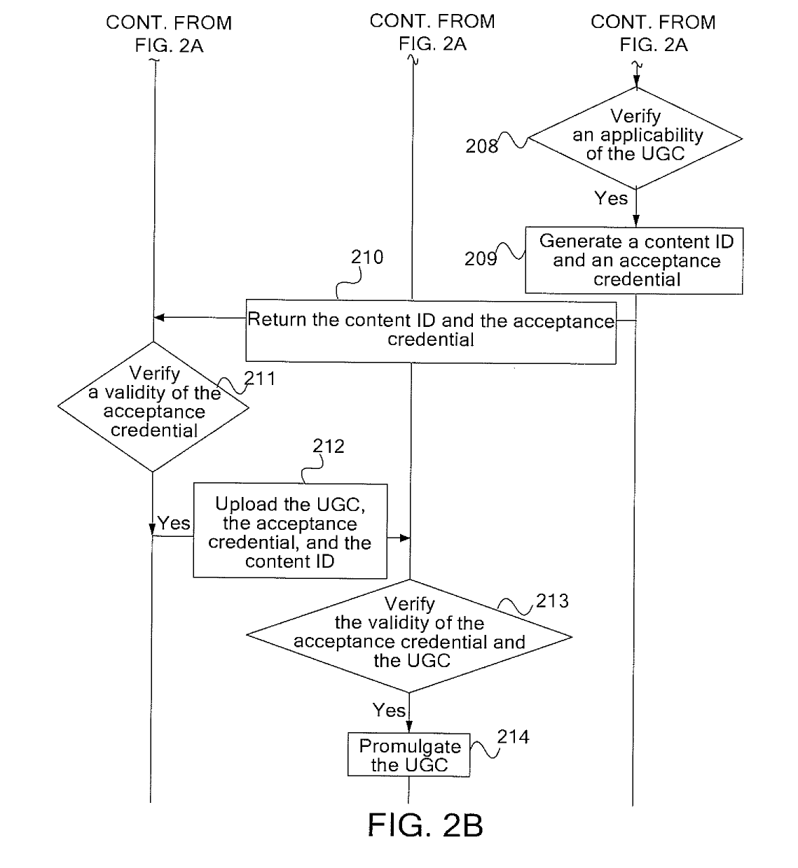

FIG. 3 is a schematic flow chart of ID registration in the embodiment of the method for registering UGC according to the present invention, that is, step 201 specifically includes the following steps.

In step 31, the user sends an ID registration request to the website, for example, the WPA, and the ID registration request carries the ID information of the user. When performing the ID registration, the user may adopt a real-name registration or a pseudo-real-name registration. As for the real-name registration, the website requires that the ID information submitted by the user when performing the ID registration is the real information of the user, for example, a real name, an ID card number, and a contact method such as a telephone number and a home address, and some other necessary personal information required by the website. As for the pseudo-real-name registration, the user adopts the certificate of the authoritative third party, for example, the certificate of the bank usually used by the user, and submits the signature of the private key required by the using of the certificate when submitting the ID registration request.

The detailed parameter description of the ID registration request may be

Enc_{RAND}(RealName_Params)+Enc_{WAP}_{_{—}}_{PubKey}(RAND+Hash(RAND+RealName_Params))

When the real-name registration is adopted, the user needs to provide the real personal ID information, the XML expression of a part of fields is shown as the following.

<Real_Name>
<Name>
real-name
</Name>
<Credential_Material>

The third party credential that can be authenticated, includes a digital certificate or an extension application of the digital certificate, and may further include a mobile phone number and other ID management information

</Credential_Marerial>
<Veri_Mode>

The verification mode is adopted by verifying the credential material. For example, the ID card number needs to be interacted with the data of the ministry of public security, and if the credential material is the digital certificate, the interaction with the delivery center of the digital certificate is needed.

</Veri_Mode>
</Real_Name>

In step 32, the WPA verifies the validity of the ID information sent by the user. If the ID information sent by the user is valid, step 33 is performed; if the ID information sent by the user is not valid, the WPA returns error information to the user. The WPA may verify whether the ID information provided by the user is true from the TTP.

In step 33, the WPA generates an ID identification corresponding to the ID information which is used to upload the UGC, and generates an ID acceptance signature which is used to bind the ID information and the ID identification. Specifically, if it is verified that the ID information provided by the user is trusted, the WPA generates the User_ID in the website for the user, connects the user ID and the ID registration information submitted by the user in series, and signs by using the private key corresponding to the public key certificate published to outside by the WPA Sign_{WPA}(Hash(Authorized_Material)+User_ID), hereafter referred to as Sign_{WPA}(P*) for short, that is, the WPA accepts the real-name or pseudo-real-name registration of the user on the website. For sake of the security, the ID acceptance signature may be encrypted.

In step 34, the ID acceptance signature is encrypted and returned to the user. The detailed operation code may be that the WPA returns Enc_{RAND}(Sign_{WPA}(P**)) to the user.

In step 35, the user verifies if the ID acceptance signature is valid, to make sure that if the ID registration is successful. If the ID registration is successful, step 36 is performed. The detailed operation code is Extract_{RAND}(Sign_{WPA}(P**).

In step 36, the ID identification is acquired. The detailed operation code is Get(User_ID).

In this embodiment, the UGC is registered by adopting the user self-application mode. The website provides the guarantee credential for the UGC. When the user performs content registration to the CIM, the user sends the UGC to be registered and the guarantee credential provided by the website to the CIM, and the CIM registers the UGC according to the guarantee credential by using a simple and feasible registration method.

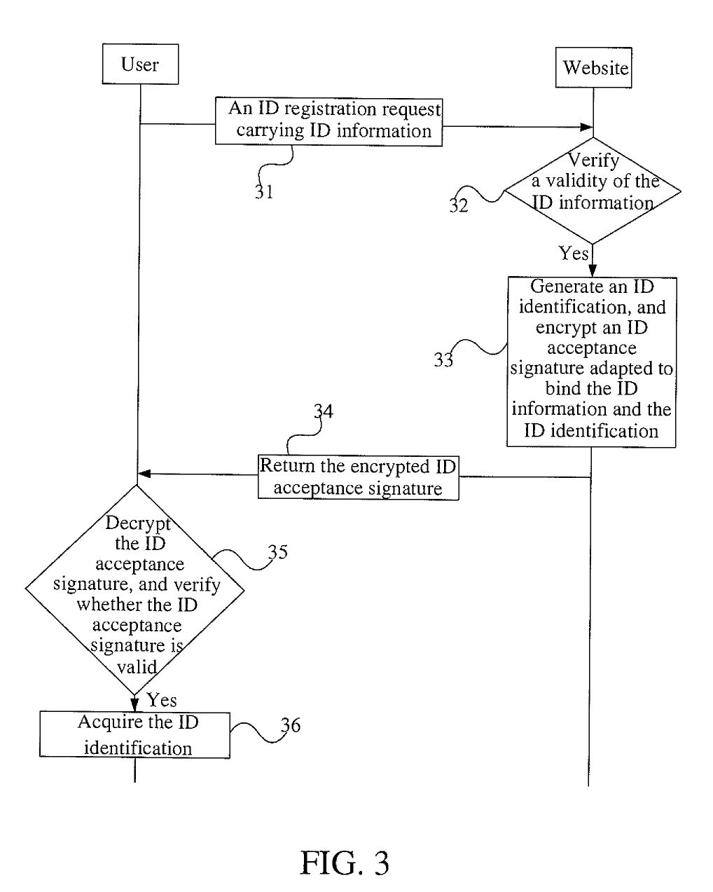

FIG. 4 is a schematic flow chart of a second example of the embodiment of the method for registering UGC according to the present invention. The embodiment includes the following steps.

In step 401, the user performs ID registration on the website to which the UGC is uploaded, for example, the WPA, so as to acquire the ID identification. The process that the user performs the ID registration on the website is the same as the process as shown in the first example.

In step 402, the user sends the proxy content registration request to the website. The proxy content registration request carries the UGC, the ID identification, and the registration mode indicating, for example, whether the user self-application mode or the website direct proxy mode is adopted. The detailed code of the content registration request may be Content_Hash+User_ID+Regist_Mode, including the content hash value Content_Hash of the UGC to be applied for registration, the ID identification User_ID, and the registration mode Regist_Mode. Meanwhile, in the sent parameter set, the content value encrypted by adopting the random number RAND generated by the user as the key, that is, Enc_{RAND}(Content) may be selectively sent.

In step 403, the website generates the guarantee credential according to the UGC and the ID identification, in which the guarantee credential is configured to bind the UGC and the ID identification. A particular code of the guarantee credential may be Sign_{WPA}(Hash(Content_Hash+User_ID+TimeStamp)) hereafter referred to as Sign_{WPA}(P*) for short, for ease of illustration. Specifically, the WPA makes the received content hash value Content_Hash, the assigned ID identification User_ID, and a relatively correct time during the operation (or a timestamp acquired from a time authoritative management entity) TimeStamp to be connected in series, performs a hash calculation, and performs a signature calculation by using a private key corresponding to a relevant public certificate of the WPA, so as to acquire the guarantee credential, for ensuring that the UGC is owned by the user having the User_ID.

In step 404, if the registration mode indicates that the website direct proxy mode is adopted, the website directly sends the content registration request to the CIM. The content registration request carries the content hash value of the UGC to be registered and the guarantee credential corresponding to the UGC and generated by the website. That is to say, a parameter description of the content registration request may be

Content_Hash+User_ID+Sign_{WPA}(P*)+TimeStamp+Sign_{WPA}(Hash(RAND_{WPA}))Enc_{CIM}_{_{—}}_{PubKey}(RAND_{WPA})

In step 405, the validity of the guarantee credential is verified. If the guarantee credential is valid, step 406 is performed.

In step 406, an applicability of the UGC is verified, that is, it is verified if the UGC can be applied for registration in the CIM management domain. If the applicability passes the verification, step 407 is performed.

For the specific algorithm of the above verification process, firstly the guarantee signature Sign_{WPA}(P*) provided by the WPA for the UGC extracted after the decryption of the encrypted data packet is verified. After the verification succeeds, it is inspected about the applicability of the UGC to be applied for registration, that is, it is ensured that no repeated application exists in the CIM management domain, and meanwhile, the attribute description relevant to the UGC is checked.

In step 407, the content ID Cntnt_ID corresponding to the UGC and an acceptance credential are generated, in which the acceptance credential is configured to bind the content ID and the guarantee credential, and is configured to enable the website waiting to receive the UGC to know that the content applied for registration is success fully registered, so as to lawfully publish the successfully registered UGC. If one of the above items does not pass the verification, error information is generated. Specifically, after the verification is finished, Cntnt_ID and an attribute description list corresponding to the UGC are triggered to be generated, and the acceptance credential which binds Content_Hash of the UGC, User_ID, WPA_URL, and TimeStamp newly acquired by the CIM is also triggered to be generated, and the relevant data is stored. The detailed parameter description of the acceptance credential may be

Sign_{CIM}_{_{—}}_{PrvKey}(Content_hash+Cntnt_ID+User_ID+WPA_URL+TimeStamp)

hereafter referred to as Sign_{CIM}_{_{—}}_{PrvKey}(*) for short.

In step 408, the CIM sends the content ID and the acceptance credential to the website through a security channel, or returns the error information to the website. That is to say, the CIM returns Sign_{CIM}_{_{—}}_{PrvKey}(*)+Cntnt_ID to the website.

In step 409, after receiving the information returned by the CIM and determining that the information is not the error information, the website verifies the validity of the acceptance credential generated by the CIM. If the acceptance credential is valid, step 410 is performed; if the acceptance credential is not valid, the process of applying the content registration through the proxy is ended. The detailed operation parameter description is Veri(Sign_{CIM}_{_{—}}_{PrvKey}(*)).

In step 410, the website sends the content ID, the acceptance credential generated by the CIM, and the guarantee credential generated by the website itself to the user, or sends the generated error information to the user.

That is to say, the website returns Sign_{CIM}_{_{—}}_{PrvKey}(*)₊Sign_{WPA}(P*) to the user.

In step 411, after receiving the information returned by the CIM and determining that the information is not the error information, the user verifies the acceptance credential generated by the CIM and the guarantee credential generated by the website. If the verification succeeds, step 412 is performed.

The detailed operation parameter description may be Veri(Sign_{CIM}_{_{—}}_{PrvKey}(*))₊Veri(Sign_{WPA}(P*)).

In step 412, the user uploads the UGC applied for registration and the corresponding content ID to the website, or sends the decryption key for the originally uploaded encrypted UGC to the website.

That is, the user uploads Content+Cntnt_ID to the website.

In step 413, the website compares whether the uploaded contents are consistent, and if the uploaded contents are consistent, step 414 is performed. The detailed operation code may be Comp(Content, Content_Hash).

In step 414, the UGC is published according to the preset policy; if the uploaded contents are not consistent, other operations are performed according to the preset policy.

In this embodiment, the UGC is registered by adopting the user self-application mode. The website provides the guarantee credential for the UGC, and sends the guarantee credential and the UGC to be registered uploaded by the user to the CIM after the website generates the guarantee credential, and the CIM registers the UGC according to the guarantee credential using a simple and feasible registration method.

Persons of ordinary skill in the art should understand that all or a part of the steps of the method according to the embodiments of the present invention may be implemented by a program instructing relevant hardware. The program may be stored in a computer readable storage medium. When the program is run, the steps of the method according to the embodiments of the present invention are performed. The storage medium may be any medium that is capable of storing program codes, such as a ROM, a RAM, a magnetic disk, and an optical disk.

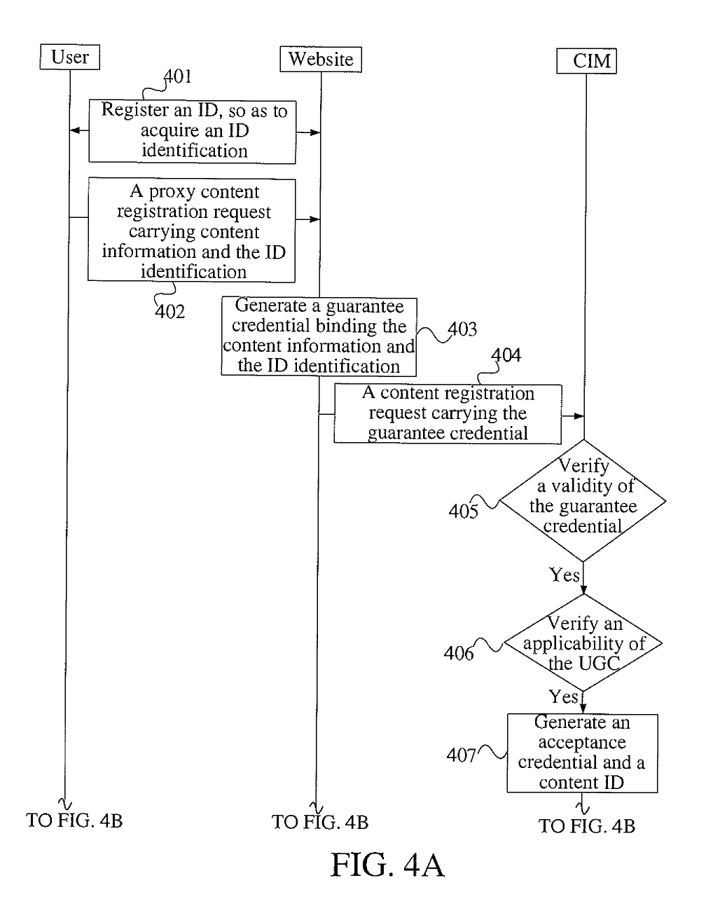

FIG. 5 is a schematic structural view of a first embodiment of a device for registering UGC according to the present invention. The embodiment includes a receiving module 51 and a registration module 52. The receiving module 51 is configured to receive a content registration request, in which the content registration request carries a UGC and a guarantee credential corresponding to the UGC, and the guarantee credential is generated by a third party network entity, for example, a website waiting to receive the UGC. The registration module 52 is configured to register the UGC according to the guarantee credential.

The receiving module 51 is configured to receive the content registration request sent by the user or the content registration request sent by the website.

The registration module 52 is specifically configured to verify the validity of the guarantee credential. If the guarantee credential is valid, the registration module verifies the applicability of the UGC, and generates a content ID corresponding to the UGC if the UGC is applicable. In order to enable the website to lawfully make the UGC to be public, when generating the content ID, the registration module generates an acceptance credential, in which the acceptance credential is configured to enable the website waiting to receive the UGC to know that the content applied for registration is successfully registered, so as to lawfully make the successfully registered UGC to be public.

In this embodiment, the website provides the guarantee credential for the UGC, so that the UGC is registered using a simple and feasible registration method.

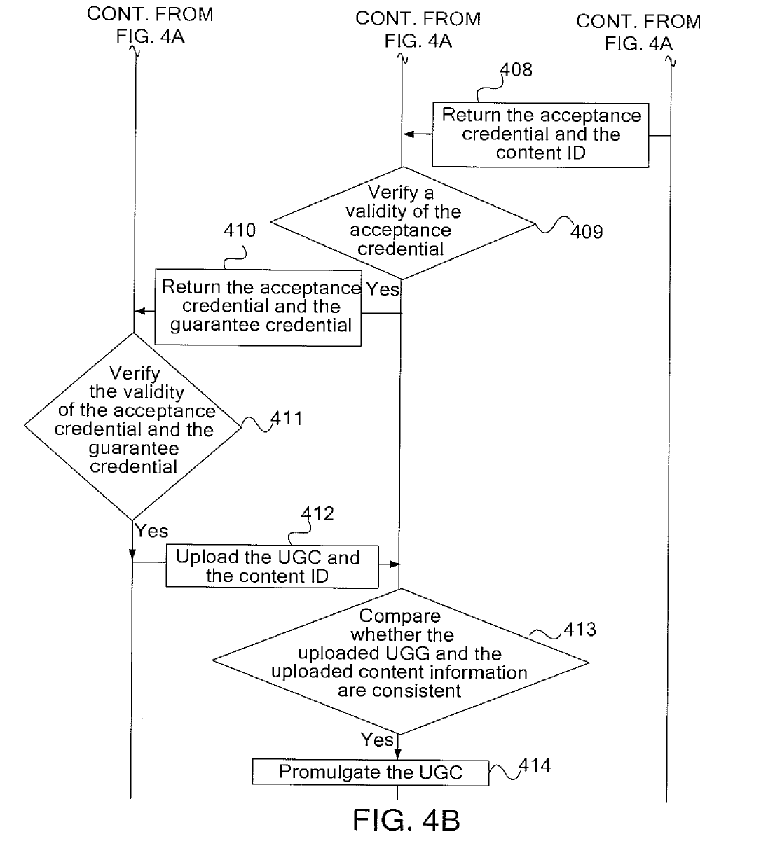

FIG. 6 is a schematic structural view of a second embodiment of the device for registering UGC according to the present invention. As compared with the first embodiment, this embodiment further includes a sending module 53. The sending module 53 is configured to directly send the content ID and the acceptance credential generated by the registration module 52 to the user, or is configured to send the content ID and the acceptance credential to the website.

In this embodiment, the website provides the guarantee credential for the UGC, so that the UGC is registered using a simple and feasible registration method. Further, a direct interaction with the user or an interaction with the website may be selected according to the registration mode, so that the registration manner is diversified.

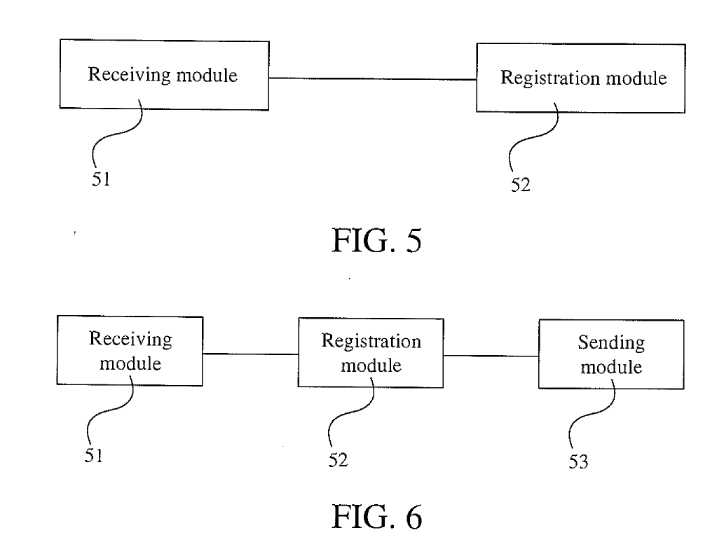

FIG. 7 is a schematic structural view of a first embodiment of a system for registering UGC according to the present invention. The embodiment includes a website 71 and a CIM 72. The website 71 is configured to receive a UGC sent by a user, and generate a corresponding guarantee credential for the UGC. The CIM 72 is configured to receive a content registration request, in which the content registration request carries the UGC and an ID identification, and the CIM is configured to register the UGC according to the ID identification.

In this embodiment, the website provides the guarantee credential for the UGC submitted by the user, so that the method for registering UGC prevents the problems of a complicated process and high cost in the prior art.

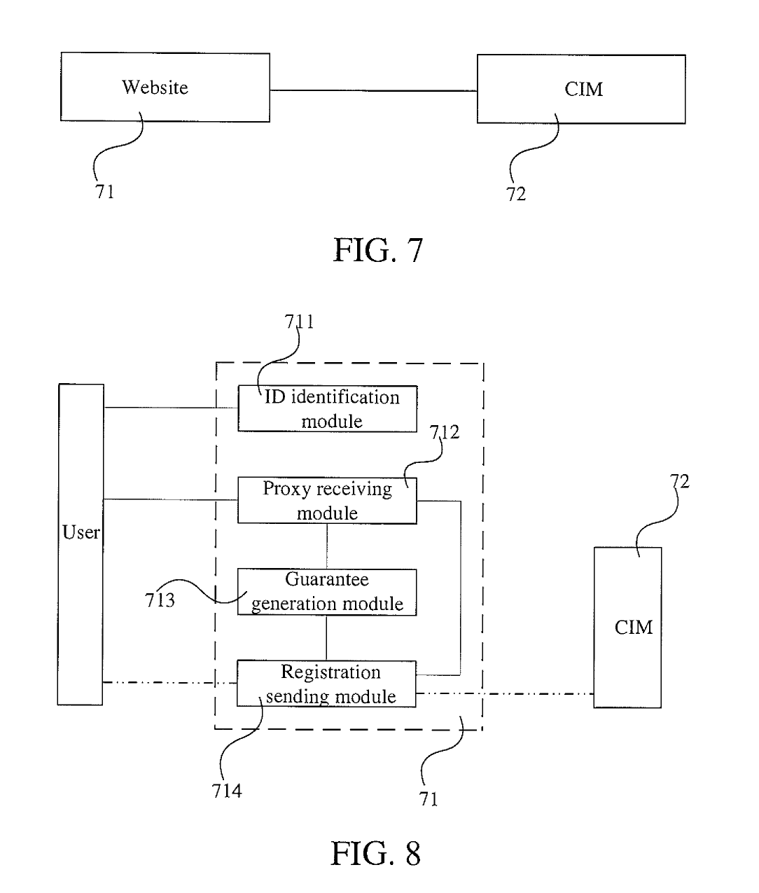

FIG. 8 is a schematic structural view of a second embodiment of the system for registering UGC according to the present invention. As compared with the first embodiment, the website 71 of this embodiment specifically includes an ID identification module 711, a proxy receiving module 712, and a guarantee generation module 713. The ID identification module 711 is configured to provide an ID identification for a user. The proxy receiving module 712 is configured to receive a proxy content registration request sent by the user, in which the proxy content registration request carries the UGC and the ID identification. The guarantee generation module 713 is configured to generate the guarantee credential for binding the UGC and the ID identification received by the proxy receiving module 712.

The proxy content registration request received by the proxy receiving module 712 further carries a registration mode. The website further includes a registration sending module 714. The registration sending module 714 is configured to send the guarantee credential generated by the guarantee generation module 713 to the user, when the registration mode received by the proxy receiving module 712 indicates that the registration adopts a user self-application mode, so that the user sends the content registration request to the CIM after verifying that the guarantee credential is valid. Alternatively, the registration sending module 714 is configured to directly send the content registration request to the CIM after the guarantee generation module generates the guarantee credential, when the registration mode indicates that the registration adopts a website direct proxy mode.

In this embodiment, the website provides the guarantee credential for the UGC submitted by the user, so that the method for registering UGC prevents the problems of a complicated process and high cost in the prior art. Further, in this embodiment, the user directly performs the registration or the website realizes the registration of the UGC as a proxy according to the registration mode selected by the user, so that method for registering UGC is simple and feasible, and is diversified.

Finally, it should be noted that the above embodiments are merely provided for describing the technical solutions of the present invention, but not intended to limit the present invention. It should be understood by persons of ordinary skill in the art that although the present invention has been described in detail with reference to the foregoing embodiments, modifications can be made to the technical solutions described in the foregoing embodiments, or equivalent replacements can be made to some technical features in the technical solutions, as long as such modifications or replacements do not cause the essence of corresponding technical solutions to depart from the spirit and scope of the present invention.

What is claimed is:

1. A method for registering user generated content (UGC), the method comprising:
receiving a content registration request, wherein the content registration request carries a UGC and a guarantee credential corresponding to the UGC, and the guarantee credential is generated by a third party network entity; and
registering the UGC according to the guarantee credential.

2. The method according to claim 1, wherein the generating of the guarantee credential, by the third party network entity, comprises:
receiving a proxy content registration request sent by a user, wherein the proxy content registration request carries the UGC;
generating an identity (ID) identification corresponding to the user; and
generating the guarantee credential, wherein the guarantee credential is configured to bind the UGC and the ID identification.

3. The method according to claim 2, wherein the proxy content registration request further carries a registration mode, and the registration mode indicates that a user self-application mode is adopted.

4. The method according to claim 1, wherein the receiving of the content registration request comprises: receiving the content registration request sent by a user; and generating, by the third party network entity, the guarantee credential and sending the guarantee credential to the user, and carrying, by the user, the guarantee credential in the content registration request after the user verifies that the guarantee credential is valid.

5. The method according to claim 2, wherein the third party network entity is a website waiting to receive the UGC, the proxy content registration request further carries a registration mode, and the registration mode indicates that a website direct proxy mode is adopted.

6. The method according to claim 5, wherein the receiving of the content registration request comprises: receiving the content registration request sent by the website; and generating, by the website, the guarantee credential, and carrying the guarantee credential in the content registration request.

7. The method according to claim 1, wherein the registering of the UGC according to the guarantee credential comprises:
verifying a validity of the guarantee credential;
verifying an applicability of the UGC, if the guarantee credential is valid; and
generating a content ID corresponding to the UGC, if the UGC is applicable.

8. The method according to claim 7, further comprising: generating an acceptance credential corresponding to the UGC, wherein the acceptance credential is configured to enable a website waiting to receive the UGC to know that the content is successfully registered.

9. The method according to claim 8, further comprising:
receiving the acceptance credential and the corresponding UGC uploaded by the user or uploading the acceptance credential and a corresponding decryption key, wherein the decryption key is configured to decrypt the pre-uploaded encrypted UGC; and
verifying the validity of the acceptance credential, and publishing the uploaded UGC or publishing the pre-uploaded UGC decrypted according to the decryption key.

10. The method according to claim 9, further comprising:
sending, by the content identity manager (CIM), the content ID and the acceptance credential to the user, wherein the acceptance credential passes a verification by the user; or
sending, by the CIM, the content ID and the acceptance credential to the website; verifying, by the website, the validity of the acceptance credential, and sending the content ID, the acceptance credential, and the guarantee credential to the user, if the acceptance credential is valid, wherein the acceptance credential and the guarantee credential pass the verification by the user.

11. A device for registering user generated content (UGC), the device comprising:
a receiving module, configured to receive a content registration request, wherein the content registration request carries a UGC and a guarantee credential corresponding to the UGC, and the guarantee credential is generated by a third party network entity; and
a registration module, configured to register the UGC according to the guarantee credential.

12. The device according to claim 11, wherein the registration module is configured to verify the validity of the guarantee credential, verify the applicability of the UGC if the guarantee credential is valid, and generate a content identity (ID) corresponding to the UGC if the UGC is applicable.

13. The device according to claim 12, wherein the registration module is further configured to generate an acceptance credential corresponding to the UGC, and the acceptance credential is configured to enable a website waiting to receive the UGC to know that the content is successfully registered.

14. The device according to claim 13, further comprising a sending module, configured to send the content ID and the acceptance credential to a user, or send the content ID and the acceptance credential to the website.

15. A system for registering user generated content (UGC), the system comprising:
a website, configured to receive a UGC sent by a user, and generate a guarantee credential corresponding to the UGC; and
a content identity manager (CIM), configured to receive a content registration request, wherein the content registration request carries the UGC and the guarantee credential, and configured to register the UGC according to the guarantee credential.

16. The system according to claim 15, wherein the website comprises:
an identity (ID) identification module, configured to provide an ID identification for the user;
a proxy receiving module, configured to receive a proxy content registration request sent by the user, wherein the proxy content registration request carries the UGC and the ID identification; and
a guarantee generation module, configured to generate the guarantee credential configured to bind the UGC and the ID identification.

17. The system according to claim 16, wherein:
the proxy content registration request received by the proxy receiving module further carries a registration mode; and the website further comprises a registration sending module;
the registration sending module is configured to send the guarantee credential generated by the guarantee generation module to the user, when the registration mode indicates that a user self-application mode is adopted, so that the user sends the content registration request to the CIM after verifying that the guarantee credential is valid; or
the registration sending module is configured to directly send the content registration request to the CIM after the guarantee generation module generates the guarantee credential, when the registration mode indicates that a website direct proxy mode is adopted.
